(19) United States
(12) Patent Application Publication
(10) Pub. No.: US 2021/0237951 A1
(43) Pub. Date: Aug. 5, 2021

(54) COMPOSTABLE FLEXIBLE MATERIAL

(71) Applicant: MUDLRK SNACKS LLC, La Porte, IN (US)

(72) Inventor: TRACE OSTERGREN, La Porte, IN (US)

(21) Appl. No.: 16/779,631

(22) Filed: Feb. 2, 2020

(51) Int. Cl. B65D 65/46; B32B 23/08; B32B 27/10; B32B 27/36; B32B 7/06; B32B 7/12; B65D 65/14; B65D 75/30

(52) U.S. Cl. CPC B65D 65/466; B32B 23/08; B32B 27/10; B32B 27/36; B32B 7/06; B32B 7/12; B32B 2439/70; B65D 75/30; B32B 2307/7163; B32B 2307/7244; B32B 2307/51; B32B 2307/7246; B32B 2307/31; B65D 65/14

(57) ABSTRACT

A compostable flexible material comprising at least two layers, wherein all of the layers of the compostable flexible material are compostable.

### BACKGROUND

Flexible materials have a wide variety of uses, from packaging materials to display boards and/or stickers. Flexible materials in use today include a combination of plastic polymer films, metal foils as sealant layers and barrier layers, and adhesives that are not compostable. Further, these conventional sealant layers are not biodegradable or compostable.

There is a need for a flexible material that has low transmission rates for water vapor and oxygen gas at both standard and tropical conditions, and is nearly 100% compostable and/or biodegradable.

### SUMMARY

The present disclosure provides a compostable flexible material comprising at least two layers of material, wherein all of the layers are compostable and/or biodegradable.

In one embodiment of the present disclosure, a compostable flexible material comprises a compostable barrier layer, a compostable sealant layer, and a compostable adhesive layer there between.

In another embodiment of the present disclosure, a compostable flexible material comprises a compostable barrier layer, a compostable sealant layer, a compostable paper layer, and a compostable adhesive layer between each of said layers.

In another embodiment of the present disclosure, a compostable flexible material comprises a compostable barrier layer, a compostable sealant layer, and compostable ink applied to at least a portion of the compostable barrier layer.

In another embodiment of the present disclosure, a compostable flexible material comprises a compostable barrier layer, a compostable sealant layer, a compostable paper layer, and compostable ink applied to at least a portion of the paper layer.

In another embodiment of the present disclosure, a compostable flexible material comprises a compostable barrier layer, a compostable sealant layer, a compostable paper layer, and a compostable ink applied to at least a portion of the barrier layer or the paper layer.

In another embodiment of the present disclosure, a compostable flexible material comprises a compostable barrier layer, a compostable sealant layer, a compostable paper layer, and a compostable ink applied to at least a portion of the barrier layer and the paper layer.

In another embodiment of the present disclosure, a compostable flexible material comprises a compostable barrier layer, a compostable sealant layer, a compostable adhesive layer therebetween, and a compostable ink applied to at least a portion of the barrier layer.

In another embodiment of the present disclosure, a compostable flexible material comprises a compostable barrier layer, a compostable sealant layer, a compostable paper layer, a compostable adhesive layer between each of said layers, and a compostable ink applied to at least a portion of the barrier layer or the paper layer.

In another embodiment of the present disclosure, a compostable flexible material comprises a compostable barrier layer, a compostable sealant layer, a compostable paper layer, a compostable adhesive layer between each of said layers, and a compostable ink applied to at least a portion of the barrier layer and the paper layer.

Those skilled in the art will further appreciate the above-mentioned advantages and superior features of the invention together with other important aspects thereof upon reading the detailed description which follows in conjunction with the drawings.

### BRIEF DESCRIPTION OF THE DRAWINGS

FIG. 1 illustrates a top perspective view of one embodiment of a compostable flexible material comprising at least three layers;

FIG. 2 illustrates a top perspective view of one embodiment of a compostable flexible material comprising at least 5 layers;

FIG. 3 illustrates a top perspective view of one embodiment of a compostable flexible material comprising compostable ink applied to at least one side of a paper layer or a barrier layer, or both;

FIG. 4 illustrates a side plan view of one embodiment of a compostable flexible material comprising at least three layers; and

FIG. 5 illustrates a side plan view of one embodiment of a compostable flexible material comprising at least five layers.

### DETAILED DESCRIPTION

The following detailed embodiments presented herein are for illustrative purposes. That is, these detailed embodiments are intended to be exemplary of the present invention for the purposes of providing and aiding a person skilled in the pertinent art to readily understand how to make and use the present invention.

Accordingly, the detailed discussion herein of one or more embodiments is not intended, nor is it to be construed, to limit the boundaries of the descriptions but rather as defined by the claims and equivalents thereof. Therefore, embodiments not specifically addressed herein, such as adaptations, variations, modifications, and equivalent arrangements, should be and are considered to be implicitly disclosed by the illustrative embodiments and claims set forth herein and therefore fall within the scope of the present invention.

Further, it should be understood that, although steps of various claimed methods may be shown and described as being in a sequence or temporal order, the steps of any such method are not limited to being carried out in any particular sequence or order, absent an indication otherwise. That is, the claimed method steps are considered capable of being carried out in any sequential combination or permutation order while still falling within the scope of the present invention.

Additionally, it is important to note that each term used herein refers to that which a person skilled in the relevant art would understand such term to mean, based on the contextual use of such term herein. To the extent that the meaning of a term used herein, as understood by the person skilled in the relevant art based on the contextual use of such term, differs in any way from any particular dictionary definition of such term, it is intended that the meaning of the term as understood by the person skilled in the relevant art should prevail.

Furthermore, a person skilled in the art of reading claimed inventions should understand that “a” and “an” each generally denotes “at least one,” but does not exclude a plurality unless the contextual use dictates otherwise. Also, the term “or” denotes “at least one of the items,” but does not exclude a plurality of items of the list.

In the description which follows, like parts are marked throughout the specification and drawings with the same reference numerals, respectively. The drawing figures may not necessarily be to scale and certain features may be shown in somewhat schematic form in the interest of clarity and conciseness.

BIODEGRADEABLE means that the material, as a whole, or each layer of a flexible material, is capable of being broken down (decomposed) naturally or rapidly by the action of microorganisms.

COMPOSTABLE means that the material as a whole, or layer of a flexible material, is capable of disintegrating in a compost environment, and complies with the compostability standards set forth by, but not limited to, the following organizations: U.S. Composting Council, Environmental Protection Agency, American Society for Testing and Materials (ASTM International), or Tüv Austria.

COMPOST ENVIRONMENT means an aerobic environment.

Biodegradable and compostable have become interchangeable terms by the public. These terms may also be interchanged in this disclosure.

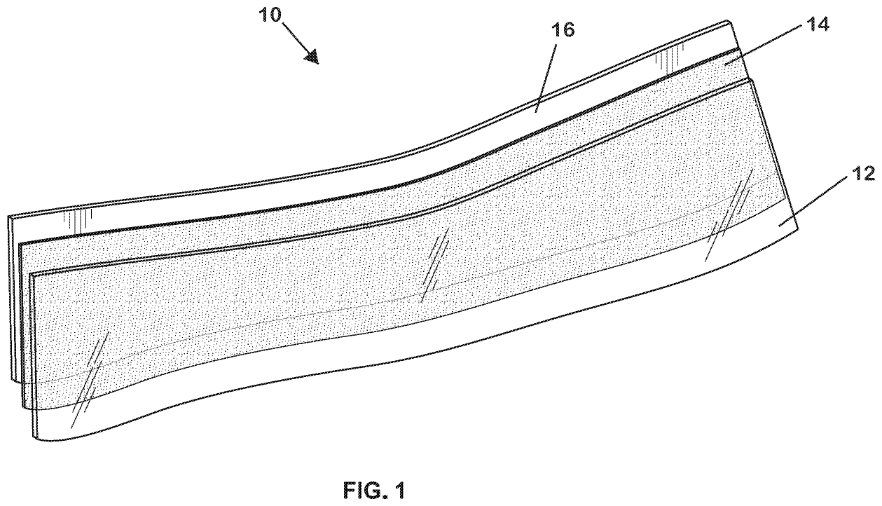

Referring to FIG. 1, there is illustrated one embodiment of a compostable flexible material and generally designated by the numeral 10. The compostable flexible material 10 can be composted and/or biodegrade within 2 months-16 months, 2 months-12 months, 2 months-10 months, 2 months-9 months, 2 months-7 months, 3 months-14 months, 3 months-10 months, 3 months-9 months, 3 months-8 months, 3 months-7 months, 3 months, 4 months, 5 months, 6 months, 7 months, 8 months, 9 months, 10 months, 11 months, 12, months, 13 months, 14 months, 15 months, 16 months, or any range of months, weeks, days therebetween. The compostable flexible material can comprise renewable resources as materials, can be certified as compostable in both industrial and/or home composting environments, and can be suitable for anaerobic digestion. The compostable flexible material 10 comprises moisture, UV/visible light, gas, aroma, oil, and grease barrier properties. The compostable flexible material 10 also comprises anti-static properties and dead-fold characteristics.

The compostable flexible material 10 can be used for any purpose that requires a flexible material, such as, but not limited to, consumer good packaging, stickers, labels, envelopes, shipping envelopes, food or edible product packaging, book covers, journal covers, notebook covers, and more. The compostable flexible material 10 is durable, and can have rigidity while still being flexible. One having ordinary skill in the art would understand how to modify the thickness of the layers or add more substrate to a respective layer to achieve a desired rigidity

The compostable flexible material 10 comprises at least two layers: a sealant layer 12 and a barrier layer 16. An adhesive layer 14 can be added therebetween, and the compostable flexible material 10 can comprise at least three layers. The at least two layers and adhesive layer 14 are each themselves compostable. The adhesive layer 14 can be a separate or stand-alone layer, as illustrated, or can be integrated into either the sealant layer 12 or the barrier layer 16 (not a stand-alone layer). Also, sealant layer 12 and barrier layer 16 can be separate or stand-alone layers, adhered to each other with adhesive layer 14, or can be integrated into each other and produced as “one layer” (not stand-alone layers). For ease of understanding this disclosure and the drawings, the sealant layer 12, adhesive layer 14, and barrier layer 16 are shown as stand-alone layers. The adhesive layer 14 can be situated between the sealant layer 12 and the barrier layer 16, and adheres the sealant layer 12 to the barrier layer 16. Once the at least three layers are adhered together, the compostable flexible material 10 is assembled, though additional layers may be added as desired.

The compostable flexible material 10 can be between 30-130 microns thick, or any range or single thickness therebetween, e.g., 35-125 microns, 40-110 microns, 45-105 microns, 50-100 microns, 35-100 microns, 60-100 microns, etc. The compostable flexible material 10 can have a heat seal strength of greater than 1,200 g/in., a water vapor transmission of less than 0.75 g/100 sq. in, (e.g. (all in g/100 sq. in) 0.74, 0.73, 0.72, 0.71, 0.70, 0.69, 0.68, 0.67, 0.66, 0.65, 0.64, 0.63, 0.62, 0.61, 0.60, 0.59, 0.58, 0.57, 0.56, 0.55, 0.54, 0.53, 0.52, 0.51, 0.50, 0.49, 0.48, 0.47, 0.46, 0.45, 0.44, 0.43, 0.42, 0.41, 0.40, 0.39, 0.38, 0.37, 0.36, 0.35, 0.34, 0.33, 0.032, 0.31, 0.30, 0.29, 0.28, 0.27, 0.26, 0.25, 0.24, 0.23, 0.22, 0.21, 0.20, 0.19, 0.18, 0.17, 0.16, 0.15, 0.14, 0.13, etc.) and an oxygen transmission of less than 0.09 cc/100 sq. in. (e.g. (all in cc/100 sq. in) 0.08. 0.075, 0.07, 0.065, 0.06, 0.055, 0.05, 0.045, 0.04, 0.035, 0.03, 0.025, 0.02, etc.).

The sealant layer 12 is a non-metalized material that is safe for contact with food. The sealant layer 12 can be a transparent cellulose film and cold-pressed or extruded through a machine polylactic acid or polylactide (PLA). PLA is a thermoplastic aliphatic polyester derived from renewable resources. The sealant layer 12 can be colored with compostable dye, if so desired. The sealant layer 12 can be transparent, semi-transparent, translucent, or opaque.

The adhesive layer 14 can be transparent, semi-transparent, translucent, or opaque material made from renewable resources. The adhesive layer 14 can be water-based long-chain adhesive polymer, which is a fully reacted system. The adhesive layer 14 can adhere to porous or non-porous substrates, and can adhere porous substrates to non-porous substrates. The adhesive layer 14 comprises a first side and a second side, and each side may be sticky. The adhesive layer 14 comprises a first side and a second side, and either the first side or the second side may be sticky. The adhesive layer 14 may be formulated as a solution, or a powder, and sprayed onto a compostable substrate, or mixed with the compostable substrate and extruded through a machine as a thin film. The adhesive property of the adhesive layer 14 is activated as the water evaporates or is absorbed by the substrate. The adhesive layer 14 can be a permanent adhesive or a pressure sensitive adhesive. A pressure sensitive adhesive is a semi-permanent adhesive that retains viscosity when it is applied to a substrate. The viscosity of the adhesive can be between 13-75 mPas, 13-70 mPas, 13-65 mPas, 15-70 mPas, 20-70 mPas, 25-70 mPas, 30-75 mPas, 35-65 mPas, or any specific viscosity therebetween. The adhesive layer 14 can be kept slightly viscous by adding more water, say 2%-15% or any % therebetween, to the standard protocol for making a fully reacted water based long-chain adhesive polymer. The adhesive layer 14 can also be turned into a pressure sensitive adhesive by adding a thin cloth to the substrate.

The adhesive layer 14 can comprise polyolefines or an aluminum substrate, and have a pH between 6-10, 7-10, 8-10, 9-10, 10, 6-7, 6-8, 6-9, 7-9, 7-8, 6, 7, 8, 9, 10, or pH values therebetween.

The barrier layer 16 can be made from renewable resources, and can be a transparent cellulose film and cold-pressed or extruded through a machine. The barrier layer 16 can be a metallized material that comprises a high luster shine or sparkle. The barrier layer 16 can have an optical density between 0.5 min. Macbeth and 3.0 max. Macbeth, or any optical density therebetween, e.g., 0.75 min, 1.0 min., 1.25 min, 1.5 min, 1.75 min, 2.0 min., 2.25 min, 2.5 min, 2.75 min., 3.0 min Macbeth. The barrier layer 16 can have a light transmission of less than 1.5%, and a tensile strength between 7,000 MD psi to 10,00 MD psi, 8,000 MD psi-9,000 MD psi, or any MD psi therebetween, e.g., 7,250 MD psi, 7,500 MD psi, 7,775 MD psi, 8,000 MD psi, 8,250 MD psi, 8,500 MD psi, 8,750 MD psi, 9,000 MD psi, 9,250 MD psi, 9,500 MD psi, 9.750 MD psi, or 10,000 MD psi.

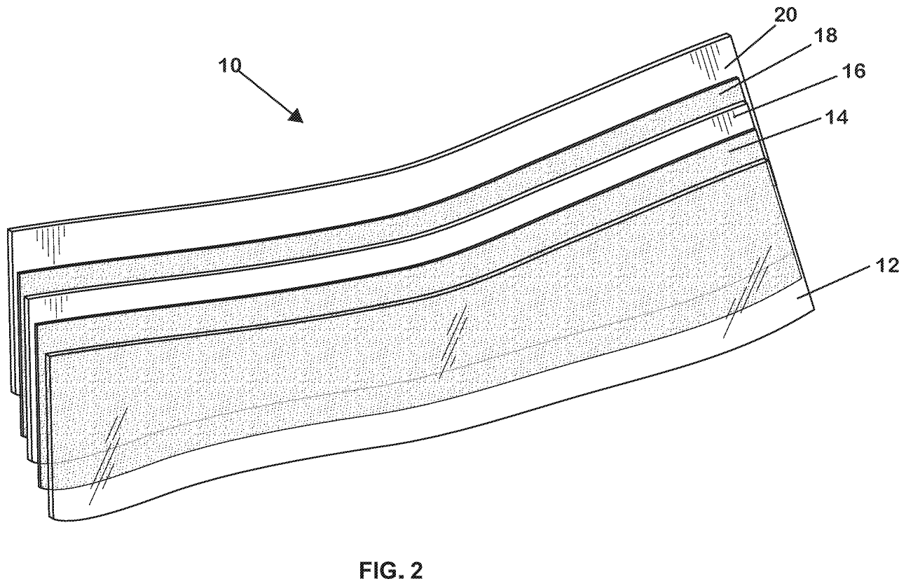

Turning to FIG. 2, another embodiment of a compostable flexible material 10 is shown. The compostable flexible material 10 can comprise renewable resources as materials, can be certified as compostable in both industrial and home composting environments, and can be suitable for anaerobic digestion. The compostable flexible material 10 comprises moisture, UV/visible light, gas, aroma, oil, and grease barrier properties. The compostable flexible material 10 also comprises anti-static properties and dead-fold characteristics.

The compostable flexible material 10 can comprise at least five layers: a sealant layer 12, at least two adhesive layers 14 and 18, a barrier layer 16, and a paper layer 20. The at least five layers are each themselves compostable. The at least two adhesive layers 14 and 18 can be separate layers, as illustrated, or can be integrated into one or both sides of either the sealant layer 12, or the barrier layer 16, or the paper layer 20. For ease of understanding this disclosure and the drawings, the at least two adhesive layers 14 and 18 are shown as stand-alone layers. One of the at least two adhesive layers 14 and 18 can be situated between the sealant layer 12 and the barrier layer 16 and adheres the sealant layer 12 to the barrier layer 16. The other of the at least two adhesive layers 14 and 18 can be situated between the barrier layer 16 and the paper layer 20, and adheres the barrier layer 16 to the paper layer 20. The adhesive layers 14 and 18 can each be a separate or stand-alone layer, as illustrated, or can be integrated into either the sealant layer 12 or the barrier layer 16 (not a stand-alone layer). Also, sealant layer 12 and barrier layer 16 can be separate or stand-alone layers, adhered to each other with adhesive layer 14, or can be integrated into each other and produced as “one layer” (not stand-alone layers). For ease of understanding this disclosure and the drawings, the sealant layer 12, adhesive layers 14 and 18, and barrier layer 16 are shown as stand-alone layers.

Once the at least five layers are adhered together, the compostable flexible material 10 is assembled, though additional layers may be added as desired.

The paper layer 20 can comprise at least one layer of paper. The paper layer 20 can comprise recycled paper or new paper, and the paper can be made from animal waste, hair, plants, fungus, fruits, vegetables, wood, or combinations thereof.

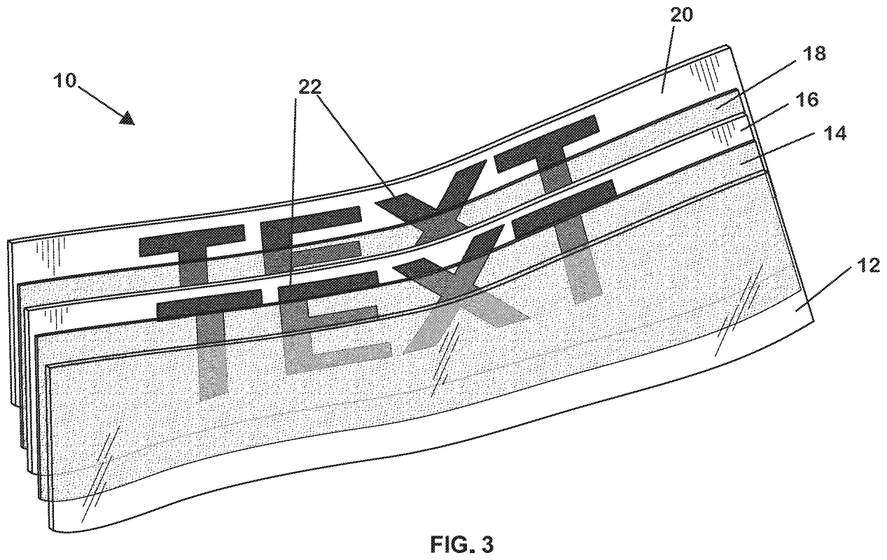

Turning to FIG. 3, another embodiment of a compostable flexible material is shown. The compostable flexible material 10 can comprise renewable resources as materials, can be certified as compostable in both industrial and home composting environments, and can be suitable for anaerobic digestion. The compostable flexible material 10 comprises moisture, UV/visible light, gas, aroma, oil, and grease barrier properties. The compostable flexible material 10 also comprises anti-static properties and dead-fold characteristics.

The compostable flexible material 10 can comprise at least three layers or at least five layers (five layers are shown in FIG. 3, though three layers can be sufficient): a sealant layer 12, an adhesive layer 14, a barrier layer 16, and optionally, an adhesive layer 18, a paper layer 20, and/or a compostable ink 22 applied to at least a portion of the barrier layer 16 or the paper layer 20. The adhesive layer 14 and adhesive layer 18 can be separate layers, as illustrated, or can be integrated into one or both sides of either the sealant layer 12, or the barrier layer 16, or the paper layer 20. For ease of understanding this disclosure and the drawings, the adhesive layer 14 and adhesive layer 18 are shown as stand-alone layers. The adhesive layer 14 can be situated between the sealant layer 12 and the barrier layer 16 and adheres the sealant layer 12 to the barrier layer 16. The adhesive layers 18 can be situated between the barrier layer 16 and the paper layer 20, and adheres the barrier layer 16 to the paper layer 20.

The adhesive layer 14 can be a separate or stand-alone layer, as illustrated, or can be integrated into either the sealant layer 12 or the barrier layer 16 (not a stand-alone layer). Also, sealant layer 12 and barrier layer 16 can be separate or stand-alone layers, adhered to each other with adhesive layer 14, or can be integrated into each other and produced as “one layer” (not stand-alone layers). For ease of understanding this disclosure and the drawings, the sealant layer 12, adhesive layer 14, and barrier layer 16 are shown as stand-alone layers.

Once the at least three layers, or optionally, the at least five layers are adhered together, the compostable flexible material 10 is assembled, though additional layers may be added as desired.

The compostable ink 22 can be made of dye made from vegetable, plants, fungus, fruit, algae, insects, treated waste, soy, water-based ink, or combinations thereof, and be substantially free of zinc, copper, nickel, cadmium, lead, mercury, chromium, molybdenum, selenium, arsenic and/or flour. The compostable ink 22 may be applied to at least a portion of the barrier layer 16. The compostable ink 22 may be applied to at least a portion of the paper layer 20. The compostable ink 22 may be applied to at least a portion of the barrier layer 16, or the paper layer 20. The compostable ink 22 may be applied to both the barrier layer 16 and the paper layer 20. The sealant layer 12 and the adhesive layer 14 may be translucent or transparent to allow the compostable ink 22 to be seen. The compostable ink 22 may be applied to either side of the barrier layer 16, or to either side of the paper layer 20, or to both sides of the barrier layer 16, the paper layer 20, or both the barrier layer 16 and the paper layer 20. The compostable ink can be laser printed, flexographic printed, digital printed, dot matrix printed, screen printed, hand written, or hand drawn on the barrier layer 16, the paper layer 20, or both the barrier layer 16 and the paper layer 20. The compostable ink 22 may be applied in the form of text, graphics, pictures, solid colors, murals, or combinations thereof. FIG. 3 is not meant to be limited to just text printed in compostable ink 22 on at least a portion of the compostable flexible material 10, the barrier layer 16, and/or the paper layer 20.

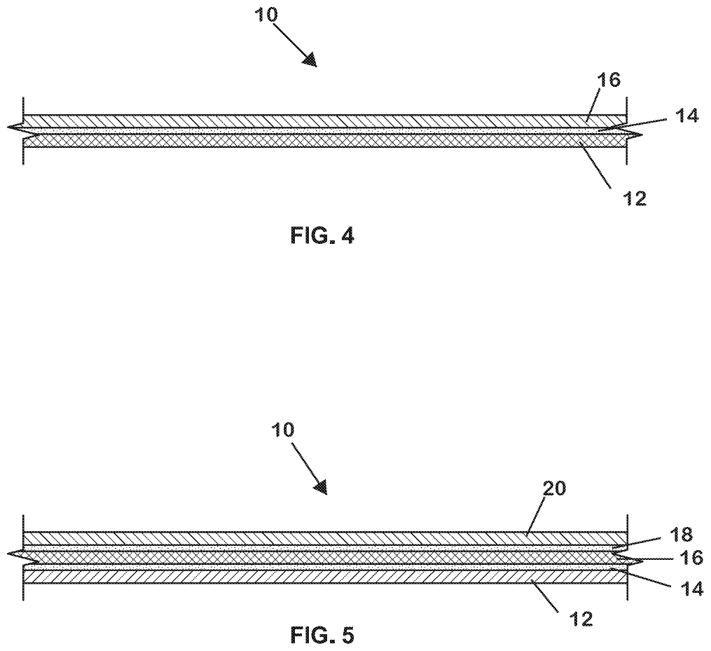

Turning to FIG. 4, a side plan view of one embodiment of the compostable flexible material 10 can be seen.

Turning to FIG. 5, a side plan view of one embodiment of the compostable flexible material 10 can be seen.

It is important to recognize that this disclosure has been written as a thorough teaching rather than as a narrow dictate or disclaimer. Reference throughout this specification to “one embodiment”, “an embodiment”, or “a specific embodiment” means that a particular feature, structure, or characteristic described in connection with the embodiment is included in at least one embodiment and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other embodiments. It is to be understood that other variations and modifications of the embodiments described and illustrated herein are possible in light of the teachings herein and are to be considered as part of the spirit and scope of the present subject matter.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

The foregoing description of illustrated embodiments, including what is described in the Abstract and the Summary, and all disclosure and the implicated industrial applicability, are not intended to be exhaustive or to limit the subject matter to the precise forms disclosed herein. While specific embodiments of, and examples for, the subject matter are described herein for teaching-by-illustration purposes only, various equivalent modifications are possible within the spirit and scope of the present subject matter, as those skilled in the relevant art will recognize and appreciate. As indicated, these modifications may be made in light of the foregoing description of illustrated embodiments and are to be included, again, within the true spirit and scope of the subject matter disclosed herein.

Thus, although the foregoing disclosure has been described in some detail by way of illustration and example for purposes of clarity and understanding, it will be obvious that certain changes and modifications may be practiced within the scope of the disclosure, as limited only by the scope of claims.

1. A compostable flexible material comprising:
at least two layers comprising a barrier layer, a sealant layer, and at least one adhesive layer therebetween, wherein each of the layers are compostable;
the barrier layer being a cellulose film;
the sealant layer being polylactide; and
the at least one adhesive layer being a fully reacted water-based long-chain polymer.

2. The compostable flexible material of claim 1, wherein the barrier layer is a metallized layer.

3. The compostable flexible material of claim 1, wherein at least one of the barrier layer, sealant layer, or adhesive layer is not a stand-alone layer.

4. The compostable flexible material of claim 3, further comprising at least two adhesive layers.

5. The compostable flexible material of claim 3, further comprising a paper layer.

6. The compostable flexible material of claim 1, further comprising compostable ink applied to at least a portion of the compostable flexible material.

7. The compostable flexible material of claim 6, wherein the compostable ink is applied to the barrier layer.

8. The compostable flexible material of claim 1, wherein the at least one adhesive layer is a pressure sensitive adhesive.

9. The compostable flexible material of claim 8, wherein the sealant layer is a removable layer.

10. A compostable flexible material comprising:
a barrier layer, a sealant layer, a paper layer, and compostable ink applied to at least a portion of the compostable flexible material;
a water vapor transmission of less than 0.75 g/100 sq. in and an oxygen transmission of less than 0.09 cc/100 sq. in;
the barrier layer being a cellulose film; and
the sealant layer being polylactide, wherein the compostable flexible material comprises.

11. The compostable flexible material of claim 10, further comprising at least two adhesive layers, wherein one of the at least two adhesive layers is placed between the barrier layer and sealant layer, and the other of the at least two adhesive layers is placed between the barrier layer and the paper layer.

12. The compostable flexible material of claim 10, wherein the compostable ink is applied to at least a portion of the paper layer.

13. The compostable flexible material of claim 10, wherein the compostable ink applied to at least a portion of the barrier layer.

14. The compostable flexible material of claim 10, wherein the compostable ink is applied to at least a portion of the barrier layer or the paper layer.

15. The compostable flexible material of claim 10, wherein the compostable ink applied to at least a portion of the barrier layer and the paper layer.

16. The compostable flexible material of claim 11, wherein the one of the at least two adhesive layers placed between the barrier layer and sealant layer is a pressure sensitive adhesive.

17. The compostable flexible material of claim 12, wherein the sealant layer is a removable layer.

18. The compostable flexible material of claim 12, wherein the sealant layer is not a removable layer.

19. The compostable flexible material of claim 11, wherein the one of the at least two adhesive layers placed between the barrier layer and sealant layer is a permanent adhesive.

20. A compostable flexible material comprising:
a barrier layer, a sealant layer, a paper layer, at least two adhesive layers, and compostable ink applied to at least a portion of the compostable flexible material;
the barrier layer being a cellulose film;
the sealant layer being polylactide; and
wherein one of the at least two adhesive layers is placed between the barrier layer and sealant layer, and the other of the at least two adhesive layers is placed between the barrier layer and the paper layer.
